(19) United States
(12) Patent Application Publication
(10) Pub. No.: US 2005/0099721 A1
(43) Pub. Date: May 12, 2005

(54) Magnetic disk drive apparatus and manufacturing method of magnetic disk drive apparatus

(75) Inventors: Yiu Sing Ho, Hong Kong (CN); Takehiro Kamigama, Hong Kong (CN); Masashi Shiraishi, Hong Kong (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: SAE Magnetics (H.K.) Ltd., Hong Kong (CN)

(21) Appl. No.: 10/979,185

(22) Filed: Nov. 3, 2004

(30) Foreign Application Priority Data
Nov. 12, 2003 (JP) 2003-382243

(51) Int. Cl. G11B 17/00

(52) U.S. Cl. 360/97.01

(57) ABSTRACT

A magnetic disk drive apparatus includes a housing member with at least one opened face, a cover member for covering the at least one opened face of the housing member, a head gimbal assembly including a magnetic head slider and a suspension for supporting the magnetic head slider, a support arm for supporting the head gimbal assembly, a magnetic disk to which the magnetic head slider opposed, and a motor for rotating the magnetic disk. The magnetic disk and the motor are attached to the housing member, and the support arm is attached to the cover member.

### PRIORITY CLAIM

This application claims priority from Japanese patent application No.2003-382243, filed on Nov. 12, 2003, which is incorporated herein by reference.

### BACKGROUND OF THE INVENTION

1. Field of the Invention

The present invention relates to a magnetic disk drive apparatus and to a manufacturing method of a magnetic head drive apparatus.

2. Description of the Related Art

In a magnetic disk drive apparatus or a hard disk drive (HDD) apparatus, a thin-film magnetic head element for writing magnetic information into and/or reading magnetic information from a magnetic disk or a hard disk is in general formed on a magnetic head slider flying in operation above the rotating magnetic disk. The slider is supported at top end section of a suspension of a head gimbal assembly (HGA).

The HDD apparatus has in general a housing member with an opened top face and a cover member for covering the top face to accommodate inside at least one magnetic disk, a drive motor for rotating the disk, at least one HGA with a magnetic head slider, a suspension and a lead conductor member, a support arm for supporting the at least one HGA, and an actuator such as a voice coil motor (VCM) for swinging the support arm in a plane parallel to the magnetic disk.

In the conventional HDD apparatus, as disclosed in Japanese patent publication No.06-215513 A2, these main components such as the magnetic disk, the drive motor, the HGA, the support arm and the VCM are attached to the housing member, but are not attached to the cover member. The cover member is used only for covering the opening of the housing member to seal the HDD apparatus.

In such the conventional HDD apparatus, both the magnetic disk with a recording surface that should be kept free of contamination and the HGA are attached to the housing member side. Therefore, when the HGA has to be replaced due to malfunctions after assembling in the HDD apparatus, it is necessary to pay close attention to prevention of the contamination of the magnetic disk surface.

In the conventional manufacturing process of the HDD apparatus, in general, first the magnetic head slider is attached to the suspension to form an HGA that has a proper size for a worker to easily handle, and then the HGA is assembled in the HDD apparatus by the worker. Thus, a thin-film magnetic head element formed on the slider is sometimes destroyed by electrostatic discharge (ESD). Thus, in case that the thin-film magnetic head element of the slider is a magnetoresistive effect (MR) element, particularly, a giant magnetoresistive effect (GMR) element or a tunneling magnetoresistive effect (TMR) element, it must give special consideration to the prevention of possible ESD destruction.

### BRIEF SUMMARY OF THE INVENTION

It is therefore an object of the present invention to provide a magnetic disk drive apparatus and a manufacturing method of a magnetic head drive apparatus, whereby, after assembling an HGA and a magnetic disk in the magnetic disk drive apparatus, the HGA can be easily replaced without inducing contamination of the magnetic disk.

Another object of the present invention is to provide a manufacturing method of a magnetic head drive apparatus, whereby ESD destruction of a magnetic head slider can be effectively prevented.

According to the present invention, a magnetic disk drive apparatus includes a housing member with at least one opened face, a cover member for covering the at least one opened face of the housing member, an HGA including a magnetic head slider and a suspension for supporting the magnetic head slider, a support arm for supporting the HGA, a magnetic disk to which the magnetic head slider opposed, and a motor for rotating the magnetic disk. The magnetic disk and the motor are attached to the housing member, and the support arm is attached to the cover member.

Because the support arm with the HGA having the magnetic head slider and the suspension are attached to the cover member, whereas the magnetic disk and the motor are attached to the housing member, it is possible to assemble the HGA in isolation from the housing member provided with the magnetic disk of which surface has to keep clean. Thus, flexibility of tools or devices used for assembling the HGA can be increased and also assembling itself can be performed with a high degree of efficiency. Furthermore, when replacing the HGA already assembled in the HDD apparatus, the replacement work can be performed by detaching only the cover member from the HDD apparatus, namely by treating only the cover member in isolation from the housing member, no contamination of the disk surface can be induced and also the replacement can be effectively executed.

It is preferred that the apparatus further includes an actuator for rotatively moving the support arm in parallel with a surface of the magnetic disk. A part of the actuator is attached to the cover member. In this case, preferably the remaining part of the actuator is attached to the housing member.

It is preferred that the HGA further includes a lead conductor member supported by or formed on the suspension, and electrically connected with the magnetic head slider.

It is also preferred that the magnetic head slider is electrically connected with the lead conductor member by solder ball bonding (SBB). By using of SBB for the electrical connection of the slider, no clamping tool utilized in the ultrasonic gold ball bonding (GBB) process is necessary. Therefore, it is possible to mount the magnetic head slider even after the assembling of the HGA.

It is further preferred that the magnetic head slider is fixed to the suspension by SBB. Because the mechanical fixing of the magnetic head slider to the suspension is performed by SBB, the resin-feeding process and the resin-curing process that are necessary when resin adhesive is used for fixing can be omitted resulting the manufacturing process to simplify. Furthermore, if it is necessary to detach the magnetic head slider from the HGA, since the mechanical fixing is executed by SBB, the slider and the suspension can be extremely easily separated from each other by heating the solder balls and by sucking and removing thus molten solder in a vacuum.

It is preferred that the magnetic head slider is fixed to the suspension by SBB at an element formed surface and/or at least one surface other than the element formed surface of the magnetic head slider.

According to the present invention, also, a manufacturing method of a magnetic disk drive apparatus, includes a step of attaching a magnetic disk and a motor for rotating the magnetic disk, to a housing member having at least one opened face, a step of attaching a support arm for supporting an HGA to a cover member, and a step of thereafter fixing the cover member to the housing member so as to cover the at least one opened face of the housing member.

Because the magnetic disk and the motor is preliminarily attached to the housing member whereas the support arm for supporting the HGA is preliminarily attached to the cover member, it is possible to assemble the HGA in isolation from the housing member provided with the magnetic disk of which surface has to keep clean. Thus, flexibility of tools or devices used for assembling the HGA can be increased and also assembling itself can be performed with a high degree of efficiency. Furthermore, when replacing the HGA already assembled in the HDD apparatus, the replacement work can be performed by detaching only the cover member from the HDD apparatus, namely by treating only the cover member in isolation from the housing member, no contamination of the disk surface can be induced and also the replacement can be effectively executed.

It is preferred that the method further includes a step of attaching at least a part of an actuator for rotatively moving the support arm in a parallel direction with a surface of the magnetic disk, in addition to the support arm, to the cover member.

It is also preferred that the method further includes a step of attaching the remaining part of the actuator, in addition to the magnetic disk and the motor, to the housing member.

It is further preferred that the step of attaching the support arm includes attaching a support arm for supporting an HGA with no magnetic head slider to the cover member, and thereafter mounting a magnetic head slider on the HGA just before the cover member is fixed to the housing member. Because the HGA with no magnetic head slider that is easily destructed by ESD is first attached to the cover member and then the magnetic head slider is mounted on this HGA just before the cover member is fixed to the housing member, ESD destruction of the magnetic head slider can be effectively suppressed.

It is preferred that the mounting of the magnetic head slider on the HGA includes fixing of the magnetic head slider to a suspension of the HGA, and electrical connection of the magnetic head slider to a lead conductor member supported by or formed on the suspension.

It is preferred that the electrical connection of the magnetic head slider to the lead conductor member is performed by SBB. By using of SBB for the electrical connection of the slider, no clamping tool utilized in the ultrasonic GBB process is necessary. Therefore, it is possible to mount the magnetic head slider even after the assembling of the HGA.

It is also preferred that the fixing of the magnetic head slider to the suspension is performed by SBB. Because the mechanical fixing of the magnetic head slider to the suspension is performed by SBB, the resin-feeding process and the resin-curing process that are necessary when resin adhesive is used for fixing can be omitted resulting the manufacturing process to simplify. Furthermore, if it is necessary to detach the magnetic head slider from the HGA, since the mechanical fixing is executed by SBB, the slider and the suspension can be extremely easily separated from each other by heating the solder balls and by sucking and removing thus molten solder in a vacuum.

It is further preferred that the fixing of the magnetic head slider to the suspension is performed by SBB at an element formed surface and/or at least one surface other than the element formed surface of the magnetic head slider.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 shows an oblique view schematically illustrating configuration of a housing member side of an HDD apparatus as a preferred embodiment according to the present invention;

FIG. 2 shows an oblique view schematically illustrating configuration of a cover member side of the HDD apparatus in the embodiment of FIG. 1;

FIG. 3 shows an exploded oblique view illustrating assembling of the HDD apparatus by attaching the cover member to the housing member in the embodiment of FIG. 1;

FIG. 4 shows a flow chart illustrating the assembling process of the HDD apparatus in the embodiment of FIG. 1; and

FIG. 5 shows a sectional view illustrating the structure for mounting the magnetic head slider in the embodiment of FIG. 1.

### DETAILED DESCRIPTION OF THE INVENTION

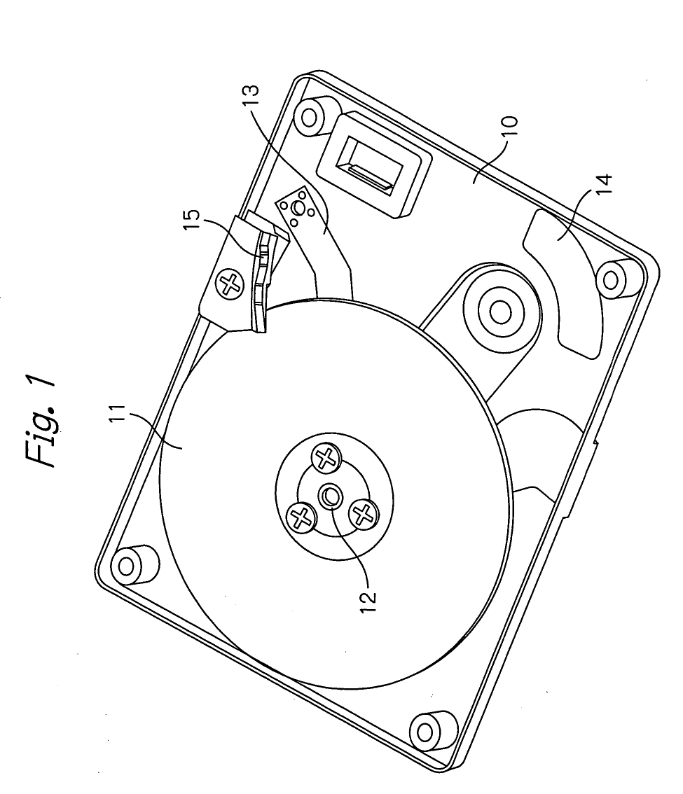

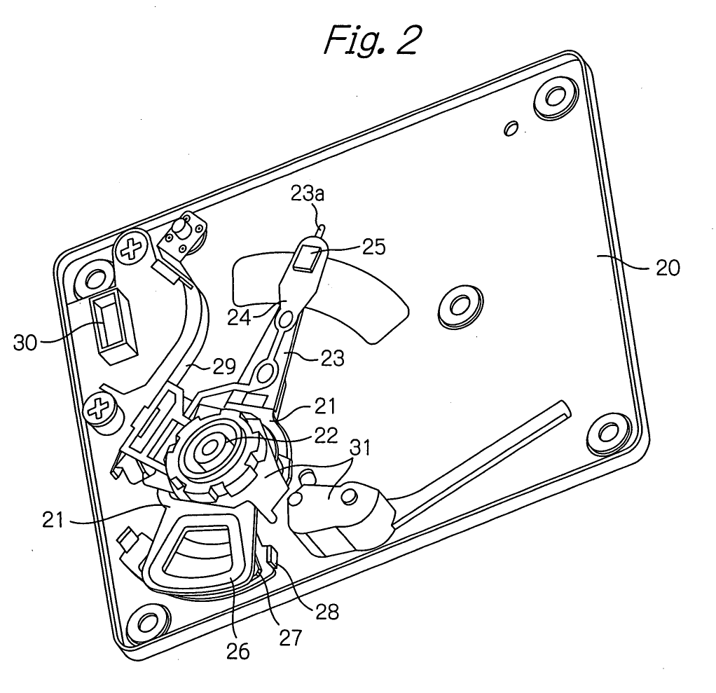

FIG. 1 schematically illustrates the configuration of a housing member side of an HDD apparatus as a preferred embodiment according to the present invention, and FIG. 2 schematically illustrates the configuration of a cover member side of this HDD apparatus.

In FIG. 1, reference numeral 10 denotes a housing member with one face opened, 11 denotes a single magnetic disk rotatably mounted on the housing member 10, 12 denotes an axis of a spindle motor (not shown) attached to the housing member 10 for rotating the magnetic disk 11, 13 denotes a lead conductor member for supplying power to the spindle motor, 14 denotes a part of a yoke section of a VCM, which is attached to the housing member 10, and 15 denotes a ramp attached to the housing member 10, on which a lift tab of a suspension (described later) sits when the magnetic head is out of operation, respectively.

In FIG. 2, reference numeral 20 denotes a cover member for covering and closing the opened face of the housing member 10, and 21 denotes a support arm made of an extremely high stiffness member and attached to a horizontal rotation axis 22 that is fixed to the cover member 20. The support arm 21 can rotate in a plane parallel to the magnetic disk 11. In FIG. 2, also, reference numeral 23 denotes a load beam made of a high stiffness member or configured to have high stiffness. This load beam 23 is fixed to the support arm 21 at the top end side with respect to the horizontal rotation axis 22. In FIG. 2, further, reference numeral 23a denotes the lift tab formed at the top end of the load beam 23, for keeping the HGA separated from the magnetic disk surface when the magnetic head is out of operation, 24 denotes a resilient flexure fixed to the load beam 23, 25 denotes a magnetic head slider mounted on the flexure 24 and provided with a thin-film magnetic head element consisting of a write head element and an MR read head element such as a GMR head element or a TMR head element, 26 denotes a coil section of the VCM, attached to the support aim 21 at the rear end side with respect to the horizontal rotation axis 22 for rotating this support arm 21, 27 denotes a magnet section of the VCM, fixed to the cover member 20, 28 denotes the remaining part of the yoke section of the VCM, fixed to the cover member 20, 29 denotes an external connection conductor member for the thin-film magnetic head element, and 30 denotes a connector with a head amplifier for amplifying a signal from the thin-film magnetic head element, respectively. The external connection conductor member 29 consists of for example a flexible print circuit (FPC) formed by a base resin layer, conductors laminated on the base resin layer and a coating resin layer, and has an IC chip.

The flexure 24 in this embodiment is made of a resilient metal plate and has a flexible tongue (not shown) at its top end section. This tongue flexibly supports the magnetic head slider 25 to provide stability in the flying attitude of the slider. On the flexure 24, a lead conductor member including a plurality of trace conductors for passing a sense current and a write current to the thin-film magnetic head and signals from the thin-film magnetic head is formed. This lead conductor member is electrically connected to the aforementioned external connection conductor member 29. The lead conductor member may be configured by directly depositing layers on the surface of the flexure 24 or by adhering a separately formed FPC on the surface of the flexure 24.

The suspension is configured by assembling the load beam 23 and the flexure 24, and the HGA is configured by assembling the suspension, the magnetic head slider 25 and the lead conductor member.

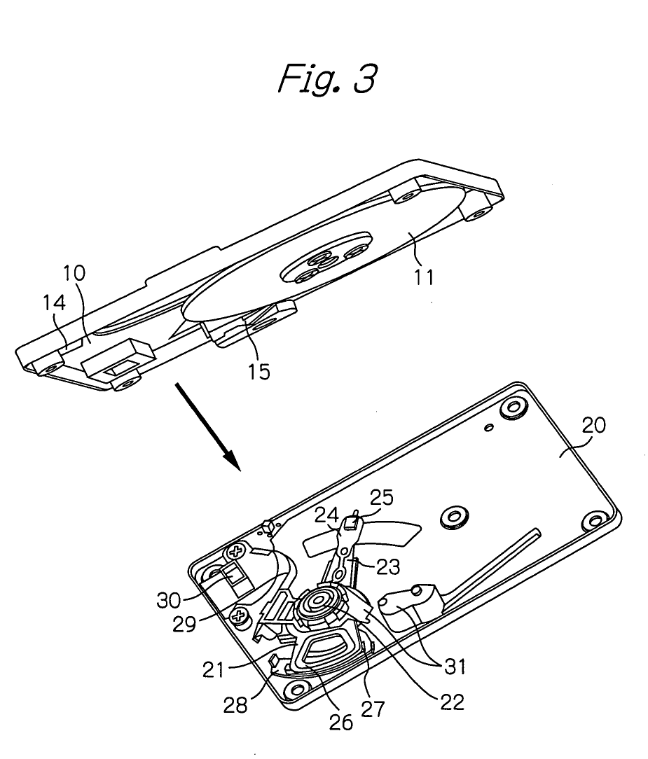

FIG. 3 illustrates assembling of the HDD apparatus by attaching the cover member to the housing member in this embodiment.

As shown in the figure, the magnetic disk 11, the spindle motor, a part 14 of the yoke section of the VCM and the ramp 15 are preliminarily attached to the housing member 10, and the horizontal rotation axis 22, the support arm 21, the coil section 26 of the VCM, the magnet section 27 of the VCM, the external connection conductor member 29 and the connector 30 are preliminarily attached to the cover member 20. Then, the cover member 20 is fixed to the housing member 10 to cover and seal the opened face of this housing member 10, so as to provide the HDD apparatus.

According to the embodiment, the support arm 21 with the HGA having the magnetic head slider 25 and the suspension are attached to the cover member 20, whereas the magnetic disk 11 and the spindle motor are attached to the housing member 10. Therefore, it is possible to assemble the HGA in isolation from the housing member 10 provided with the magnetic disk 11 of which surface has to keep clean, resulting that flexibility of tools or devices used for assembling the HGA can be increased and also assembling itself can be performed with a high degree of efficiency. Furthermore, when replacing the HGA already assembled in the HDD apparatus, the replacement work can be performed by detaching only the cover member 20 from the HDD apparatus, namely by treating only the cover member 20 in isolation from the housing member 10, no contamination of the disk surface can be induced and also the replacement can be effectively executed.

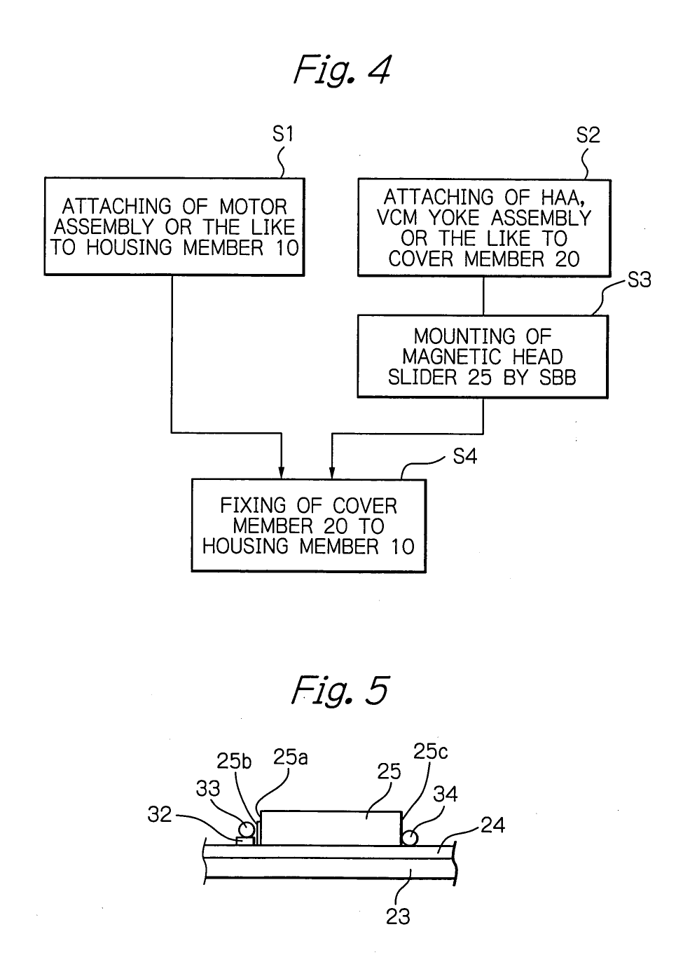

FIG. 4 illustrates flow of the assembling process of the HDD apparatus in this embodiment.

First, to the housing member 10, a motor assembly consisting of the spindle motor, the magnetic disk 11 and the like, the part 14 of the yoke section of the VCM, the ramp 15, and other necessary components are preliminarily attached (Step S1).

On the other hand, to the cover member 20, a head arm assembly (HAA) consisting of the support arm 21 to which the HGA except for the magnetic head slider 25 is mounted, the horizontal rotation axis 22, the coil section 26 of the VCM and the like, a VCM-yoke assembly consisting of the magnet section 27 of the VCM and the remaining part 28 of the yoke section of the VCM, the external connection conductor member 29 including the connector 30, and other necessary components are preliminarily attached (Step S2).

Just before the cover member 20 is fixed to the housing member 10 after all the necessary components are attached to this cover member 20, the magnetic head slider 25 is mounted on the flexure 24 of the HGA (Step S3). The mounting of the magnetic head slider 25 on the flexure 24 is performed by SBB. That is, as shown in FIG. 5, electrical connections of terminal electrodes 25b formed on an element formed surface or trailing surface of the magnetic head slider 25 with connection pads 32 that are a part of the lead conductor member are performed by SBB using solder balls 33, and also mechanical fixing of the magnetic head slider 25 to the suspension is performed by SBB using solder balls 34 disposed between the trailing surface 25a and/or a surface 25c deferent from the trailing surface 25a of the magnetic head slider 25 and the flexure 24. Because SBB is used for both the electrical connection and the mechanical connection of the slider 25, no clamping tool utilized in the ultrasonic GBB process is necessary to use. Therefore, it is possible to mount the magnetic head slider 25 even after the assembling of the HGA. Also, because the mechanical fixing of the magnetic head slider 25 to the suspension is performed by SBB, the resin-feeding process and the resin-curing process that are necessary when resin adhesive is used for fixing can be omitted resulting the manufacturing process to simplify. Furthermore, if it is necessary to detach the magnetic head slider 25 from the HGA, since the mechanical fixing is executed by SBB, the slider 25 and the flexure 24 can be extremely easily separated from each other by heating the solder balls and by sucking and removing thus molten solder in a vacuum.

Thereafter, the cover member 20 is fixed to the housing member 10 to close the opened face of the housing member 10 to finish the HDD apparatus (Step S4).

As aforementioned, an HGA with no magnetic head slider that is easily destructed by ESD is first attached to the cover member 20, and then the magnetic head slider 25 is mounted on this HGA just before the cover member 20 is fixed to the housing member 10. Therefore, according to this embodiment, ESD destruction of the magnetic head slider 25 can be effectively suppressed.

In the above-mentioned embodiment, the HDD apparatus has a single magnetic disk and a single support arm with an HGA, wherein the magnetic disk and the spindle motor are attached to the housing member 10 with the single opened face, the support arm 21 with the HGA is attached to the cover member 20, and this cover member 20 is fixed to the housing member 10 to cover the single opened face. However, in a modification, the HDD apparatus may have a single magnetic disk and two support arms with the respective HGAs. In the modification, a housing member to which the single magnetic disk and a spindle motor are attached has two opened faces opposed with each other, and two cover members each having an HGA and a support arm are attached from both sides to cover the two opened faces, respectively.

Many widely different embodiments of the present invention may be constructed without departing from the spirit and scope of the present invention. It should be understood that the present invention is not limited to the specific embodiments described in the specification, except as defined in the appended claims.

1. A magnetic disk drive apparatus comprising:
a housing member with at least one opened face;
a cover member for covering said at least one opened face of said housing member;
a head gimbal assembly including a magnetic head slider and a suspension for supporting said magnetic head slider;
a support arm for supporting said head gimbal assembly;
a magnetic disk to which said magnetic head slider opposed; and
a motor for rotating said magnetic disk,
said magnetic disk and said motor being attached to said housing member, and said support arm being attached to said cover member.

2. The apparatus as claimed in claim 1, wherein said apparatus further comprises an actuator for rotatively moving said support arm in parallel with a surface of said magnetic disk, a part of said actuator being attached to said cover member.

3. The apparatus as claimed in claim 2, wherein the remaining part of said actuator is attached to said housing member.

4. The apparatus as claimed in claim 1, wherein said head gimbal assembly further includes a lead conductor member supported by or formed on said suspension, and electrically connected with said magnetic head slider.

5. The apparatus as claimed in claim 1, wherein said magnetic head slider is electrically connected with said lead conductor member by solder ball bonding.

6. The apparatus as claimed in claim 1, wherein said magnetic head slider is fixed to said suspension by solder ball bonding.

7. The apparatus as claimed in claim 6, wherein said magnetic head slider is fixed to said suspension by solder ball bonding at an element formed surface and/or at least one surface other than said element formed surface of said magnetic head slider.

8. A manufacturing method of a magnetic disk drive apparatus, comprising the steps of:
attaching a magnetic disk and a motor for rotating said magnetic disk, to a housing member having at least one opened face;
attaching a support arm for supporting a head gimbal assembly to a cover member; and
thereafter fixing said cover member to said housing member so as to cover said at least one opened face of said housing member.

9. The manufacturing method as claimed in claim 8, wherein said method further comprises a step of attaching at least a part of an actuator for rotatively moving said support arm in a parallel direction with a surface of said magnetic disk, in addition to said support arm, to said cover member.

10. The manufacturing method as claimed in claim 9, wherein said method further comprises a step of attaching the remaining part of said actuator, in addition to said magnetic disk and said motor, to said housing member.

11. The manufacturing method as claimed in claim 8, wherein said step of attaching the support arm includes attaching a support arm for supporting a head gimbal assembly with no magnetic head slider to said cover member, and thereafter mounting a magnetic head slider on said head gimbal assembly just before said cover member is fixed to said housing member.

12. The manufacturing method as claimed in claim 11, wherein said mounting of said magnetic head slider on said head gimbal assembly includes fixing of said magnetic head slider to a suspension of said head gimbal assembly, and electrical connection of said magnetic head slider to a lead conductor member supported by or formed on said suspension.

13. The manufacturing method as claimed in claim 12, wherein said electrical connection of said magnetic head slider to said lead conductor member is performed by solder ball bonding.

14. The manufacturing method as claimed in claim 12, wherein said fixing of said magnetic head slider to said suspension is performed by solder ball bonding.

15. The manufacturing method as claimed in claim 14, wherein said fixing of said magnetic head slider to said suspension is performed by solder ball bonding at an element formed surface and/or at least one surface other than said element formed surface of said magnetic head slider.
